(19) United States
(12) Patent Application Publication
(10) Pub. No.: US 2008/0319832 A1
(43) Pub. Date: Dec. 25, 2008

(54) SEARCH METHODS AND SYSTEMS USING PERIODIC PAYMENT DATA TO IDENTIFY ITEMS BY LUMP SUM VALUE

(76) Inventors: Jayme T. Liebe, Waunakee, WI (US); David M. Kettner, Waunakee, WI (US)

Correspondence Address: CRAWFORD MAUNU PLLC, 1150 NORTHLAND DRIVE, SUITE 100, ST. PAUL, MN, 55120, US

(21) Appl. No.: 12/143,108

(22) Filed: Jun. 20, 2008

Related U.S. Application Data
(60) Provisional application No. 60/945,802, filed on Jun. 22, 2007.

(51) Int. Cl. G06Q 30/00; G06F 17/30; G06Q 40/00

(52) U.S. Cl. 705/10; 707/5; 705/38; 705/14; 705/26; 707/E17.017

(57) ABSTRACT

Embodiments of the present invention provide a method and system for identifying items for purchase by the consumer using a computer. The method and system is premised on the search for items based on the amount of a periodic payment to be paid by the purchaser for the item, whether by daily, weekly, bi-weekly, monthly, quarterly, annual or other payment structure. In identifying items for consideration by the purchaser, the method and system may further consider any tax, insurance, maintenance, or other fees typically associated with such items. Items applicable to the present method and system include those items for which a periodic payment may be used to purchase that item, including real estate, automobiles, boats, airplanes, electronics, home appliances, furniture, remodeling services or medical services.

This application claims benefit of U.S. Provisional Application No. 60/945,802, filed on Jun. 22, 2007.

### FIELD OF THE INVENTION

Embodiments of the present invention relate to systems and methods for searching and identifying items by their lump sum value using search criteria that include periodic payment information.

### BACKGROUND

The use of the internet and other network systems has revolutionized the manner in which consumers shop for goods and services. Often these searches involve the use of a search engine designed to help find information stored on a computer system. The most public and visible form of search engine is a web search engine, such as Google™ and Yahoo!™, which searches the world wide web for items of interest based on a search query entered by the user. The search query is typically expressed as a set of words that identify the desired concept that documents relevant to the search may contain. The results are then displayed based on a ranking system employed by the search engine. How a search engine decides which pages are the best matches, and what order the results should be shown in, varies widely from one engine to another.

A vast majority of search engines, to the extent they are publicly accessible, are commercial ventures supported by advertising revenues. The revenues are typically generated by either allowing advertisers to pay fees in order to ensure that their listings are ranked higher in search results or by running search related ads alongside the regular results displayed. In the latter case, the advertiser pays a fee every time a consumer clicks on one of the ads.

The online advertising model has become a multi-billion dollar business in recent years. Although successful, the business has not yet recognized its full potential as most advertising is still nationally focused due to today's product and service markets being free from geographic limitations. Even if a search is focused on a particular location, the complexities of matching a local advertisement with a general search query is often difficult to overcome such that a market for local advertising on public search engines has been slow to materialize. This presents a problem as more and more users move to the internet as its primary information source. As a result, traditional local advertisement resources, such as newspapers, yellow pages, and magazines, continue to decline in circulation, thereby reducing the opportunities for local businesses to advertise their goods and services.

Most search engines are run by private companies using proprietary algorithms and private databases. Such systems are generally focused on specific topical areas, goods or services. In the real estate context, the most prominent collection of private databases is the Multiple Listing Service (MLS), a group of private databases which allow real estate brokers to widely share information about properties available for purchase. Using search tools available on real estate agent or broker websites, potential buyers may view properties available on the market using search features such as location, type of property (single family, lease, vacant land, duplex), property features (number of bedrooms and bathrooms), and price ranges specific to the purchase price of the home. Many allow for saving search criteria and for daily email updates of newly-available properties.

Other prominent search engines are directed towards facilitating online shopping for vehicles (cars, trucks, motorcycles, boats, bicycles), consumer electronics, home appliances, furniture, travel services, and pretty much any other product or service that a consumer may be interested in purchasing. As with real estate, potential buyers may view items available on the market using criteria such as location, type of product, brand name, desired features of the product or service, and price ranges specific to the purchase price of the product or service. Once the product or service is identified, the purchaser may then initiate a purchase directly through the website or by contacting the seller.

In each of the above instances, the consumer is required to know the purchase price that they are willing to pay for the product or service. However, a number of relatively high priced products are typically purchased by making periodic payments, such as through an installment plan, mortgage or other type of loan from a lending institution (car loan, boat loan, etc.). In such instances, the consumer is required to work directly with a lending institution or loan calculator to determine the price range for the product they can afford. Once the price range is established, the consumer can then use the applicable search engine to find the products or services of interest.

This approach often fails to take into consideration other fees and expenses typically associated with the product or service. For real estate, such fees and expenses often include property taxes and insurance, closing costs, mortgage insurance, title insurance, utility costs and more. The result is that the ultimate periodic purchase payment obligation is greater than anticipated by the consumer, and may be in excess of what the consumer can actually afford or has budgeted.

The traditional purchase price approach to searching also presents opportunities for the consumer to be presented with search results not truly within the scope of the desired interests of the consumer. Online shopping databases, including most MLS search engines, often group their products based on established price ranges from which the query is selected. The consumer is therefore required to select the price range that best reflects their estimated purchase limits. Because these ranges tend to be broad so as to enhance database management and to provide exposure to more products, the consumer may be required to sift through the results to identify those products within their budget or, in the worst case, be placed in a position where they are considering products that they truly cannot afford.

### SUMMARY

Various aspects of the present invention are directed to systems and methods for implementation by a computer arrangement, the systems and methods facilitating access and processing of a plurality of item-related data sets stored in a database, each item-related data set corresponding to a respective item and including a respective lump sum payment value. The systems and methods perform steps of receiving an access request that indicates an amount to be paid periodically, algorithmically computing a lump sum parameter indicative of a lump sum payment amount as a function of the amount to be paid periodically, and transmitting search criteria including the generated lump sum parameter to identify items in the database at least by the associated lump sum payment value. The identified items may be stored and displayed and, in certain embodiments, may be displayed along with advertisements that are selected based on the identified items and/or based on one or more of the search criteria.

Other aspects of the present invention are directed to computer readable media that include computer executable instructions adapted to perform, or data arranged for use with, a computer-implemented method for facilitating access and processing of item-related data sets stored in a database, each item-related data set corresponding to a respective item and including a respective lump sum payment value. The method includes the steps described above.

The periodic payment amount may be entered as a range, a fixed amount, or as an amount that varies over time, or may be calculated based on the entry of income level, financial obligations or status of the consumer. The lump sum parameter may also include non-recurring expenses, such as down payments, interest rate points, service fees, closing costs, processing fees, sales taxes, and service plan fees, or recurring expenses, such as property taxes, insurance and maintenance costs.

In certain embodiments, the systems and methods are directed to item-related data sets relating to real estate. In addition to the periodic payment amount, the search criteria may include, without limitation, a state, county and/or municipality designation, property type, building style, number of bedrooms, offices, garage stalls, bathrooms and/or floors, building age, lot size, or any other characteristics common to the real estate decision making process.

In certain embodiments, the systems and methods are directed to item-related data sets relating to vehicles. In addition to the periodic payment amount, the search criteria may include, without limitation, the type of vehicle, and the vehicle size, color, model, style or age.

In certain embodiments, the systems and methods are directed to item-related data sets relating to financeable consumer products, such as electronic devices, home appliances and furniture. In addition to the periodic payment amount, the search criteria may include the type of product and characteristics generally associated with that product.

In certain embodiments, the systems and methods are directed to item-related data sets relating to various types of services, including, without limitation, dental, medical, investment, travel and remodeling services. In addition to the periodic payment amount, the search criteria may include the type of service and characteristics generally associated with that service. With respect to remodeling services, and in addition to the periodic payment amount, the search criteria may include, without limitation, the type of remodel to be undertaken, the products and services to be included in the remodel, and the quality or type of products and services.

The above summary is not intended to describe each embodiment or every implementation of the present disclosure. The figures and detailed description that follow more particularly exemplify various embodiments.

### BRIEF DESCRIPTION OF THE DRAWINGS

The invention may be more completely understood in consideration of the included description in connection with the accompanying drawings, in which:

FIG. 1A schematically shows an environment in which systems and methods in accordance with certain embodiments of the present invention may be implemented;

FIG. 1B schematically shows functions performed in accordance with certain embodiments of the present invention;

FIG. 2 illustrates an example query model that may be used in accordance with certain embodiments of the present invention;

FIG. 3 illustrates steps that may be performed in accordance with certain embodiments of the present invention;

FIG. 4 illustrates steps that may be performed in accordance with certain embodiments of the present invention;

FIG. 5 illustrates steps that may be performed in accordance with certain embodiments of the present invention;

FIG. 6 illustrates steps that may be performed in accordance with certain embodiments of the present invention;

FIG. 7 illustrates steps that may be performed in accordance with certain embodiments of the present invention;

FIG. 8 illustrates steps that may be performed in accordance with certain embodiments of the present invention; and

FIG. 9 illustrates an example search report that may be displayed in accordance with certain embodiments of the present invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention.

### DETAILED DESCRIPTION

The present invention provides methods and systems for identifying items for purchase using a periodic payment amount. Specific embodiments of the invention can be used to process data to generate data sets conforming to one or more search parameters and protocols. The generated data sets can be used to identify items that have a lump sum purchase value and which may be paid for using periodic payments (e.g., under an installment plan or mortgage), such as real estate, vehicles, electronics, appliances, furniture, and any other item, product or service purchased on a payment plan. Searchers or other users of the systems and methods may include the consumer, lenders, brokers, sales representatives, service providers, and their assistants or agents.

In certain embodiments, the systems and methods of the present invention calculate a lump sum parameter from a specified periodic payment amount, range of period payment amounts, or range of financing terms, and so forth. The lump sum parameter may be expressed as a single value, as a range of values, as multiple single values or ranges, or any combination. The lump sum parameter is used alone or together with other search criteria to identify items from data sets stored in a database, the data sets including at least one lump sum payment value associated with each item. The specified periodic payment amount may be provided directly, or may be calculated based on factors such as income, financial obligations, current rent or mortgage payment, expected changes in financial or family status, or any other factor that may be used to generate budgeting plans over short or long term periods. As such, the specified periodic payment may be reflective of a regular payment plan affordable to a particular user.

In a specific embodiment, the systems and methods of the present invention are designed for use with various financial software applications and protocols. Examples include, but are not limited to, Open Financial Exchange File (OFX), Open Financial Connectivity File (OFC), or Quicken Import File (QIF). The system can provide the user with the option of uploading such data files, which can contain a number of different financial indicators of a particular user, such as income, liabilities, expenses, spending habits, available funds, and the like. The uploaded information can form a part of a user profile, which can be used to generate the search criteria. Many programs provide the ability to interface with remote servers using established protocols. Embodiments of the present invention take advantage of this ability by providing the user with the option of uploading the information from the software application with which they are familiar.

Because the data sets to be searched include a lump sum value for the items, a lump sum parameter is calculated from the period payment information. The lump sum parameter may be calculated using additional information (relevant to the financial transaction), such as interest rates (which are optionally determined from user credit worthiness, published rates, or provided by a lending institution), payment term, one-time or re-occurring fees or expenses associated with the item (which may be concurrently financed with the purchase of the item), and so forth. Multiple values can be included in the lump sum parameter, for example each value representing a calculation based on the periodic payment amount and different financing terms such as a 30 year fixed rate mortgage and a 15 year fixed rate mortgage. In another example, the lump sum parameter may be calculated based on different interest rates or other financial terms offered by competing lending institutions, the search results being provided along with advertisements in accordance with embodiments described herein. As a further example, the lump sum parameter may be calculated based on financial terms available given the user's credit score along with financial terms available for improved credit scores, the search results being provided along with advertisements or links to providers of credit counselling or other such services for helping users achieve improved credit worthiness levels. In each of these instances, the individual user may directly compare search results for different financing terms given the same or similar periodic payment data.

The lump sum parameter may also be calculated by accounting for other ongoing expenses, such as insurance, property taxes, or association, storage or slip fees, among others. As a result, the individual user is able to directly search for items of interest in a manner that more accurately represents the cost of purchasing and maintaining that item and which is more reflective of the budget that the purchaser can truly afford.

In certain embodiments, the present invention employs a computer interface for searching. For example, the computer is connected to a communication server that uses the internet to connect to a host processor. The host processor in turn is connected to a database containing information regarding various items of interest to the user. Alternatively or additionally, the computer is connected to a host processor which is further connected to a database. As such, the invention may be practiced within the internal network of a product seller or agent to assist the user in identifying items for sale, rent or lease.

In the practice of certain embodiments of the invention, a query screen of the computer prompts a user to enter specific characteristic information regarding the item of interest and the amount of the installment payments to be made. The query may also include the entry of a down payment, the number of installment payments to be made, the timing and term over which installments are to be made, or other information pertinent to the proposed payment model. In certain embodiments, the installment amount may be calculated or estimated from other information provided by the user, and optionally additional information such as current interest rates that may be gathered, for example from networked databases. A query search is initiated based on the periodic payment amount, along with any other search criteria, to identify relevant items from the database.

The search is conducted by comparing the characteristics of the item of interest to the lump sum parameter calculated based on the desired installment payment, the time period over which such payments are made, applicable interest rates, down payments, if any, and other such information. For example, the lump sum parameter may represent a present value amount that may be directly compared to the lump sum value information for the items stored in the database. For purposes of illustration, and without loss of generality, various aspects of the present invention are exemplified in terms of calculating a present value amount for the items.

The search criteria used to identify items in the database can also include other characteristics, which will generally depend on the type of item of interest. For example, if the item is real estate, the characteristics may include, without limitation, a state, county and/or municipality designation, the type of property (vacant lot, commercial, residential, condominium, single-unit property, multi-unit property, etc.), the style of the building (colonial, cape cod, etc.), the number of bedrooms, offices, garage stalls, bathrooms and/or floors, the age of the building, the size of the lot, or any other characteristics common to the decision making process in the real estate market. If the item is motorized transportation, the characteristics may include, without limitation, whether the vehicle is a motorcycle, automobile, truck, airplane, boat, train or other type of vehicle, and the vehicle size, color, model, style or age. Searchable items may also include bicycles, furniture, electronics and the characteristics typically associated with such items.

Embodiments of the present invention are also applicable to financeable consumer products, such as electronic devices, home appliances and furniture. For electronic devices, the characteristics may include, without limitation, the type of electronic device (such as a television, stereo, computer, camera, etc.), and the characteristics typically associated with such devices. For home appliances, the characteristics may include, without limitation, the type of appliance (such as a washer, dryer, refrigerator, dishwasher, oven, grill, etc.) and the characteristics typically associated with such appliances. For furniture, the characteristics may include, without limitation, the type of furniture (such as a sofa, chair, table, bedroom furniture, etc.) and the characteristics typically associated with such furniture.

Embodiments of present invention are also applicable to various types of services which may allow for the payment of those services through a payment plan (with or without amortization). Such services may include, without limitation, dental services, medical services (including cosmetic and reconstructive surgery), investment services and remodeling services. With respect to remodeling services, the characteristic information may include, without limitation, the type of remodel to be undertaken (such as kitchen, bathroom, office, dining room, living room, bedroom, etc.), the products and services to be included in the remodel (such as new appliances or furniture, cabinets, sinks, flooring, countertops, painting, etc.), and the quality or type of products and services. Embodiments of the present invention are also applicable to travel services.

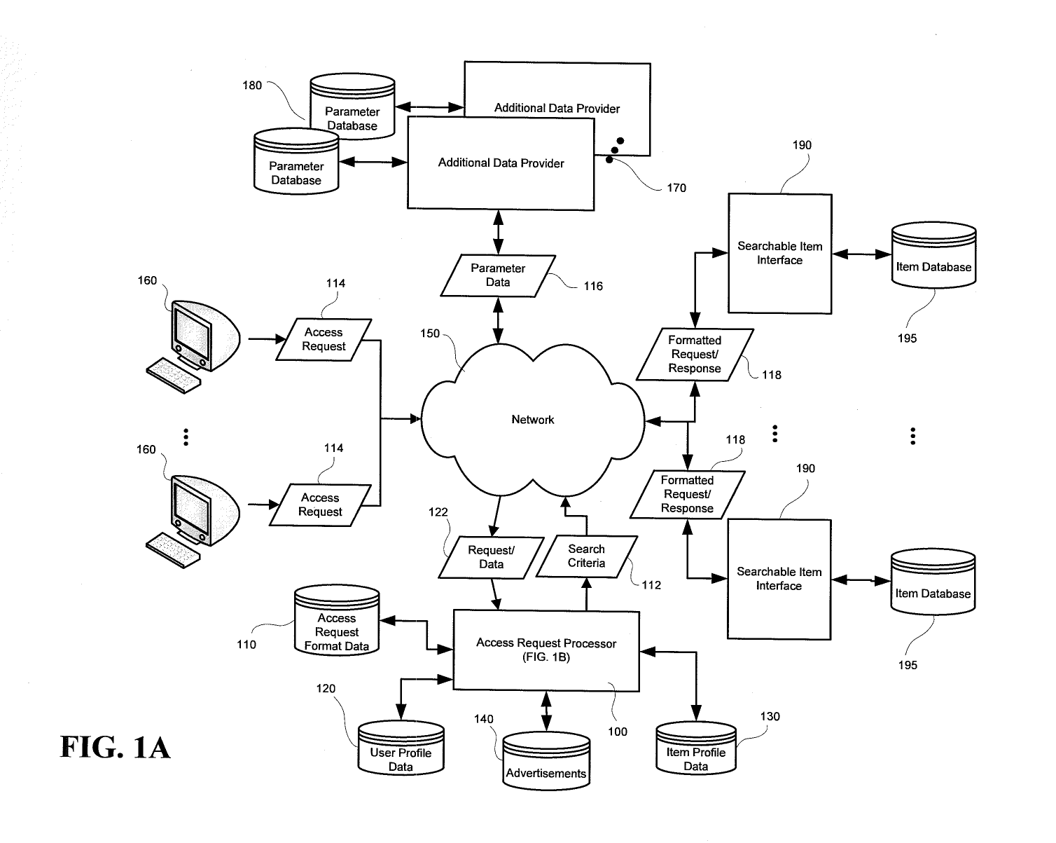

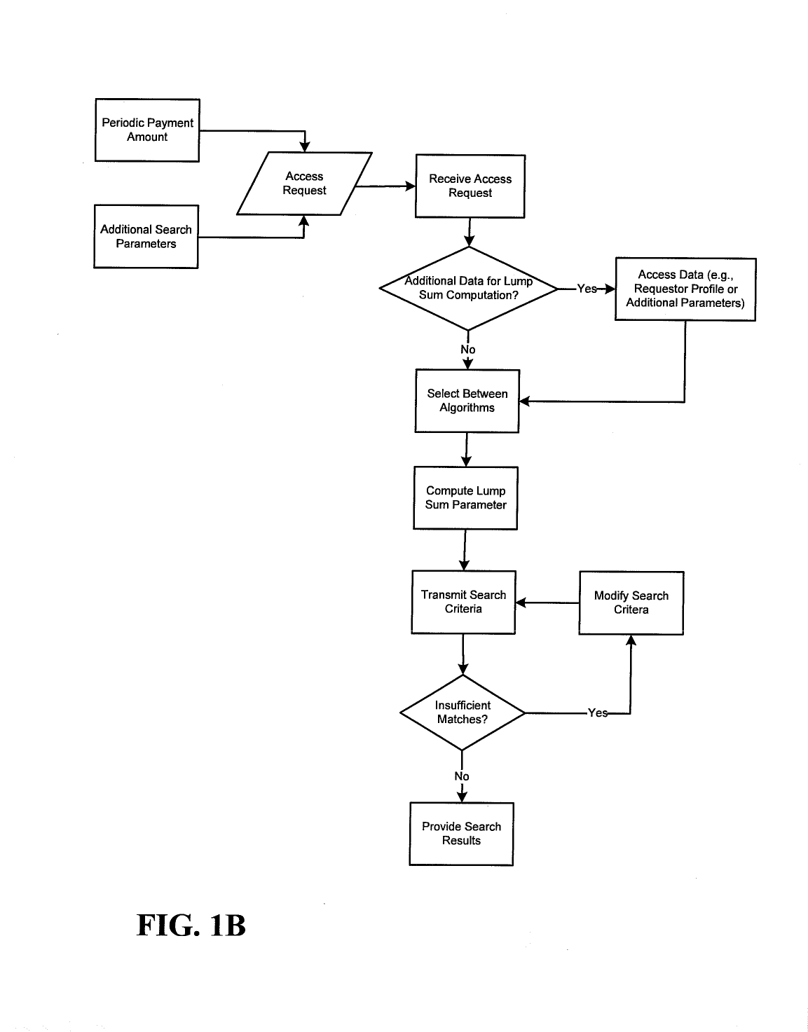

FIG. 1A illustrates an exemplary environment for implementing various aspects of the present invention. As will be appreciated, the environment in FIG. 1A is merely illustrative, and the various components shown may be optional or provided in an alternative manner (for example, multiple components being combined into a single component). Furthermore, the arrows indicating communication between the various components indicate some of the possible communications paths, although it will be appreciated that the various components may also communicate in other ways.

In FIG. 1A, an access request processor 100 receives an access request 114 that includes a periodic payment amount, algorithmically computes a lump sum parameter, and transmits search criteria 112 (including the lump sum parameter) for the identification of items stored in one or more item databases 195. Processor 100 can receive access requests 114 from user access terminals 160, which may include computer arrangements in which the processor 100 is housed or which may include computers or dummy terminals that are networked to the processor 100, for example through network 150 (for example, any suitable network including a private local area network, the Internet, and so forth). The access request may be received along with other data 122 that the processor 100 can use to develop the search criteria 112. The processor 100 may also access other databases for information to develop the search criteria. For example, the processor 100 may access a request format database 110 that includes information helpful in generating a set of usable search criteria 112 from the access request 114. In a specific implementation the request format database 110 provides information used to format the access request according to the specific database(s) being accessed. This can be particularly useful when the items to be searched reside in a variety of different databases (e.g., different databases for real estate located in different states or different databases for different stores/Internet sites). The processor 100 may also access a user profile database 120 that includes individualized information associated with one or more users generating the access requests. For example, the user profiles may include searching preferences, information for computation of the lump sum parameter (for example, income, credit worthiness, and so forth), interest level indicators generated from prior searches, and so forth. The processor 100 may also access an item profile database 130 that includes characteristics associated with the particular items being searched.

The developed search criteria 112 may be transmitted for identification of items from the item database(s) 195, for example via network 150. To formulate formatted requests 118 suitable for processing by a searchable item interface 190 and for searching the item data sets, it may be beneficial for certain parameter data 116 derived from the search criteria 112 to be transmitted to one or more additional data providers 170 for access of information from parameter databases 180 used to refine and properly format the search request. For example, user profile data may be transmitted to a credit reporting service to determine a credit worthiness indicator, which in turn can be used to determine interest rates for calculation of the lump sum parameter of the search criteria. Alternatively, a credit reporting service can provide a user of the reporting service with the option of using the access request processor 100. In one instance, the credit reporting service can provide a user-selectable link to the access request processor. The user can manually enter the credit information or the credit service provider can send the credit information. In another instance, the credit reporting service can use the access request processor 100 without redirecting the user to a different website/interface. The credit reporting service can request the necessary data from the user and use the access request processor 100 to generate formatted search requests. This flexibility allows the credit reporting service differing levels of control in the process. A similar interaction can be implemented with a variety of service/goods providers other than credit reporting services including, but not limited to, consumer review sites, search engines, financial loan providers and real estate providers.

The formatted search requests 118 are used by the searchable item interface 190 to search item database 195 by comparing search parameters with stored information relating to the items. A search result response 118 may be transmitted back to processor 100 for additional action such as storing, sorting, and displaying. In certain embodiments, the processor 100 may access a database of advertisements 140 for selection and display of advertisements based on one or more characteristics of the identified items, one or more search parameters, and/or one or more characteristics stored in the user profile. The selected advertisements may be displayed along with the identified items. The particular format of the item or advertisement display may be personalized according to the user profile.

FIG. 1B exemplifies certain functions of the processor 100 shown in the environment of FIG. 1A. A database access request may be generated based on a periodic payment amount and (optionally) additional search parameters. The generation of the access request may be performed at processor 100, or remotely. The processor receives the access request, and calculates a lump sum parameter based on the periodic payment amount. If additional data is used to make the lump sum parameter computation, the additional data may be accessed, for example from a requester profile, from a database that includes current interest rates, and so forth. Depending on the data gathered for computation of the lump sum parameter, different computation algorithms may be selected. For example, there may be different algorithms for fixed rate financing versus variable rate financing. There may also be different algorithms depending on whether periodic payment information is provided as a single amount, as a range, or expressed in terms of affordability factors such as income, current financial obligations, and credit worthiness. Search criteria that include the computed lump sum parameter along with any other search parameters may be transmitted for comparison to item parameters stored in the database(s). If the search results are insufficient due to insufficient data or search criteria that are overly broad or overly narrow, the user may be prompted to modify the search criteria. The search results may then be provided for storage, sorting, and/or display. Optionally, user feedback may be received based on the provided search results, for example to refine the search criteria to produce better matching. In some embodiments, items that do not fully match the search criteria (for example, properties that are in regions adjacent to the searched region) may be provided as a suggestion for consideration by the user, and to obtain further feedback (positive or negative). User feedback may be stored as part of a user profile, for example to facilitate future search requests.

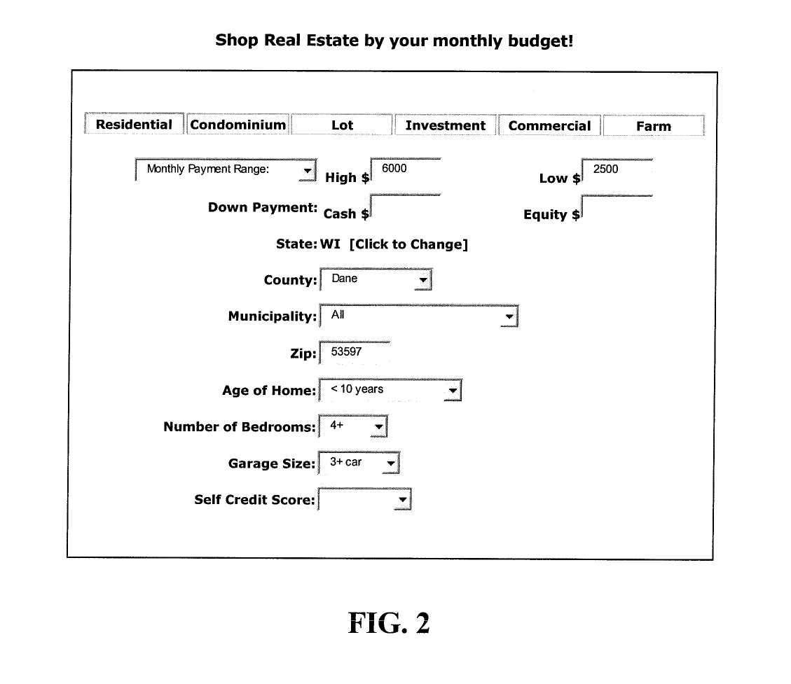

In certain embodiments, the lump sum parameter represents a present value amount (Pv) that is calculated based on the desired installment payment and the number of payments to be made over a period of time. In some instances, the calculation may also include the amount of down payment to be made, a credit worthiness indicator for the consumer, any applicable taxes, whether one time or recurring, insurance and any other miscellaneous costs associated with that item (for example, upkeep, utilities, and so forth). The installment may be based on any number of structures, whether daily, weekly, bi-weekly, monthly, quarterly, annual or other payment structure typical for the item of interest. The time period for making the installment payments will generally depend on the price of the item and the period in which the consumer desires or is able to pay for that item. For example, most homes are purchased through a mortgage which requires a monthly payment amortized over a period of 15, 20, 30 or 40 years. The mortgage may be established as a fixed rate mortgage, an adjustable rate mortgage, an interest only loan, an equity loan, or any other type of lending product then being offered by a lender. In such instances, the user would input the desired monthly payment and the period of the loan. The user may also input a down payment amount or a down payment range, the type of lending product and an indicator of credit worthiness to assist in the calculation. FIG. 2 provides an illustration of one query model useful for real estate properties.

The calculation of Pv is typically performed by a processor in communication with the computer into which the query information was entered. The calculation is intended to determine the present value of the cumulative amount of the installment payments made by the consumer, discounted for any interest associated with such payments. In one embodiment, the calculation may also include a discount for the taxes to be paid by the consumer as included in the purchase price or as may be levied by the applicable state, county or municipality, such as property taxes. In another embodiment, the calculation may also take into consideration the typical insurance payment to be made for that item (such as home owners insurance, auto insurance, warranty coverage, etc.). In yet another embodiment, the calculation may also take into consideration other miscellaneous fees associated with the item, such as association fees typical for condominiums or private development communities, and maintenance or warranty fees associated with certain electronic devices and appliances.

In exemplary embodiments, Pv is further adjusted to provide a Pv range to allow for a broader selection of items that meet the selection criteria. The Pv range may be entered directly by the user or calculated by establishing an upper Pv value (uPv) greater than or equal to Pv and a lower Pv value (lPv) less than or equal to Pv. The uPv and lPv may be calculated according to any one of several methods, including by multiplying the Pv by certain percentages selected by the host, consumer or lender, by the addition or subtraction of an established value, or by a direct entry by the user. In certain embodiments, the uPv and lPv are established by the user through the input of an installment payment range on the query screen and the subsequent calculation by the processor of the uPv and lPv as describe above based on those entered values. In another embodiment, the uPv is calculated by increasing the Pv by a factor of at least 1%, or by a factor of less than either 5%, 10%, 15%, 20%, 25% or 50%. In another embodiment, the lPv is calculated by decreasing the Pv by a factor of at least 1%, or by a factor of less than either 5%, 10%, 15%, 20%, 25% or 50%.

Once the Pv or Pv range is calculated, the processor then retrieves records from a database containing information about the collection of items relevant to the interests of the consumer. The selection is performed by matching the Pv or Pv range with those items including at least one of the characteristics, and preferably at least of majority of the characteristics, and most preferably all of the of characteristics of the item as entered by the user. In the event that no items are selected due to the absence of a match, a message indicating as such is provided to the user. In one embodiment, the message further includes the query information used for making the selection and the ability for the user to modify the query information to make a new selection.

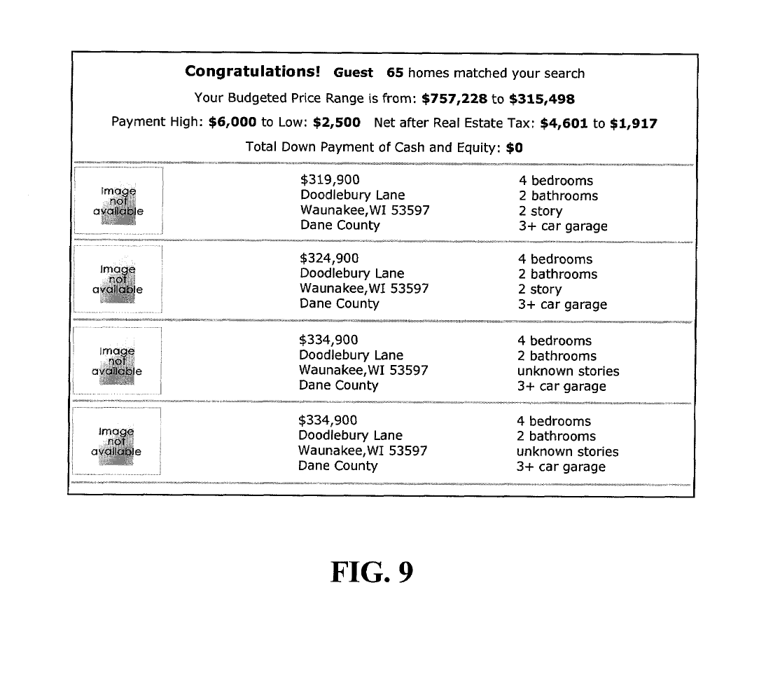

The results of the selection are transmitted to the user and displayed in a report. The typical report may be displayed at the computer terminal of the user, but may also be provided to the user in the form of a printed report. In one embodiment, the results are reported on a display screen associated with the computer terminal as illustrated on FIG. 9. The results may be listed in a summary format providing minimal information regarding the item, or in a detailed format providing detailed information regarding the item. In the summary format, the results may be displayed in a manner which allow for the user to select any one or more of the items listed in the results in order to view more detailed information regarding the item.

The results may also be displayed on a display screen that also includes additional information for the user to consider or use. For example, the display screen may include the criteria used by the processor to make the selection of items provided in the report, such as the installment payment amount, payment period, interest rate, the Pv or Pv range, and any taxes, insurance or other fees included in the calculation. The display screen may also include a query section for modifying the selection criteria and for initiating additional searches. In one embodiment, the display screen also includes information or advertisements regarding individuals or entities that provide products or services associated with the items, such as lenders, brokers, sales agents, legal representatives, contractors, shipping services, insurance providers, installers, etc. In yet another embodiment, the user may gain access through the results screen to more detailed information regarding such individuals or entities.

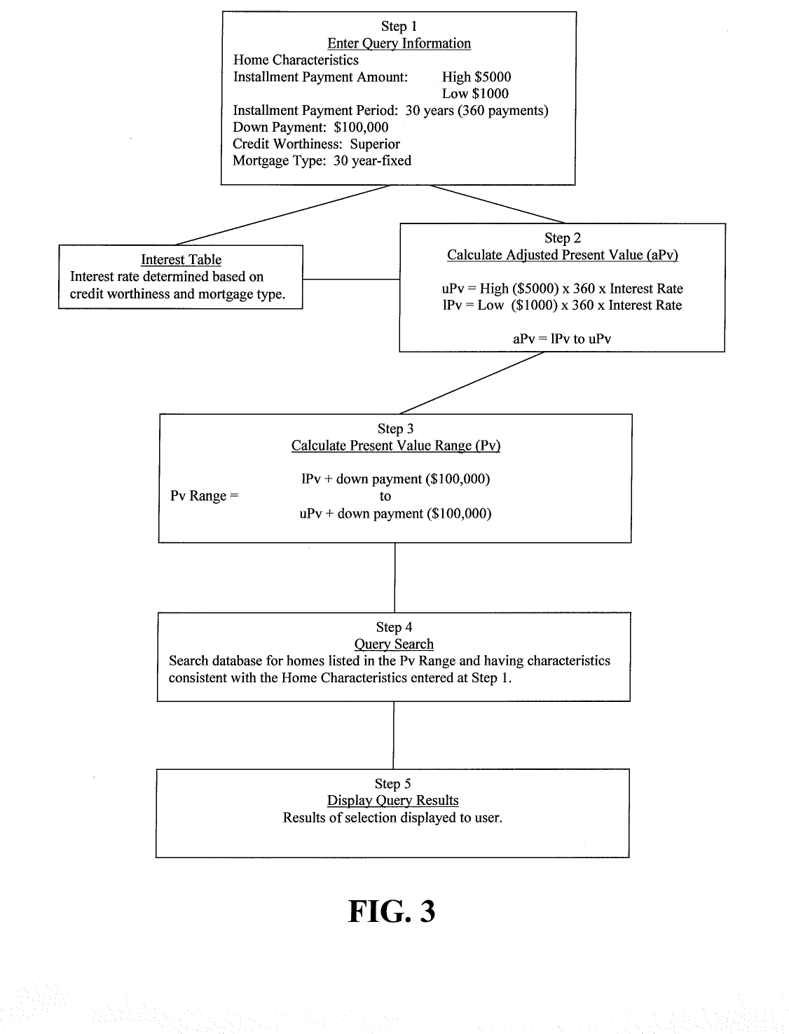

FIG. 3 illustrates one method for calculating the present value for the purchase of a residential home. The user enters on the query screen at step 1 the characteristics of the desired home, a range for the desired installment payment amount, the number of payments to be made, a down payment amount, a credit worthiness indicator, and the preferred mortgage type. At step 2 the processor calculates an adjusted present value (aPv) range by multiplying each of the upper and lower installment payment amounts (IPA) by the number of payments, and then adjusting each item by an interest rate determined in accordance with the credit worthiness indicator and the type of mortgage. The interest rate may be established by the host, a subscribing lender or broker, or from a public or private database posting mortgage interest rates. At step 3 the down payment amount is added to each calculated aPv value to provide the Pv range. The processor then identifies at step 4 those items having a price within the Pv range and which include at least one of the characteristics of the item as entered by the user. The results of the selection are then displayed to the user at step 5.

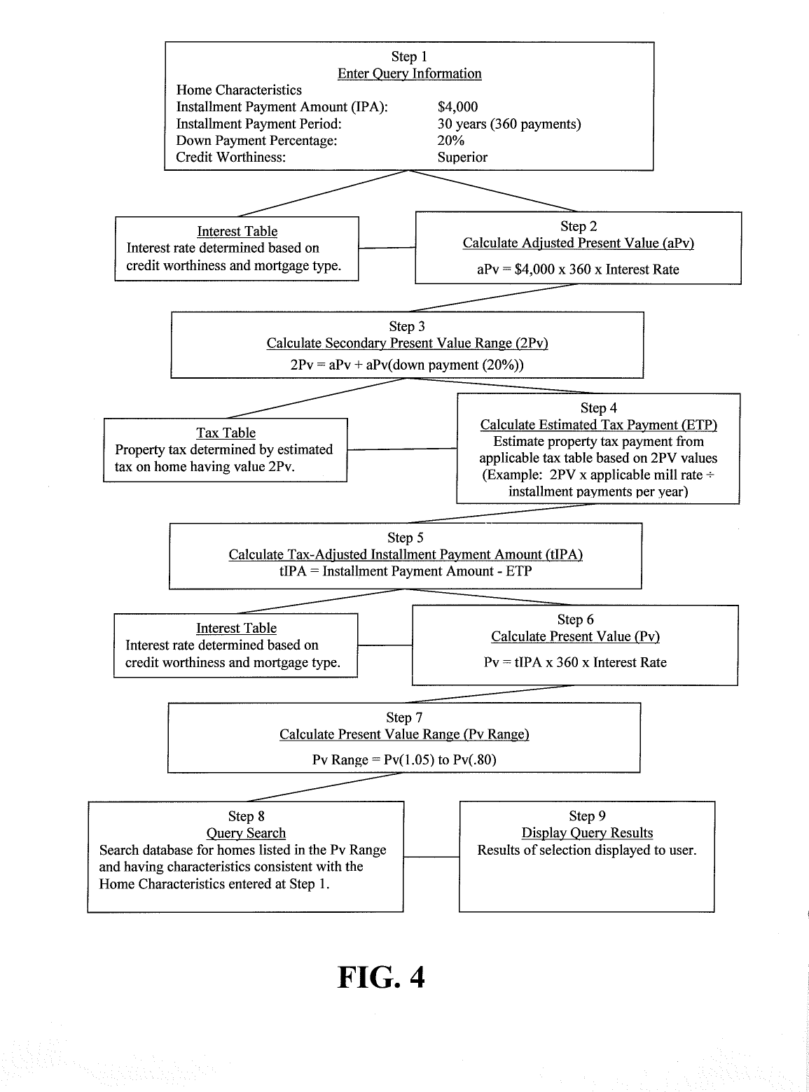

FIG. 4 illustrates yet another method for calculating the present value for the purchase of a residential house, but including a discount for annual property taxes to be paid on the home. The user has entered on the query screen in step 1 the characteristics of the desired home, the desired installment payment amount, the number of payments to be made, a twenty percent (20%) down payment, and a credit worthiness indicator for the purchaser. At step 2 the processor calculates an adjusted present value (aPv) by multiplying the installment payment amount (IPA) by the number of payments, and then adjusting the product by an interest rate determined in accordance with the credit worthiness indicator and the type of mortgage. At step 3 the aPv is further adjusted by the down payment percentage entered by the user to provide a secondary present value (2Pv) reflecting the aPv plus the calculated down payment. At step 4 an estimated annual property tax amount is calculated based on a property assessed at 2Pv in the municipality selected by the user, and then divided by the number of installment payments per year selected by the user to obtain an estimated tax payment (ETP). The estimated annual property tax amount may be calculated by dividing 2Pv by 1000 and multiplying its product by the posted mill rate for the municipality. Alternatively, the estimated annual property tax amount may be retrieved directly from the property listings having at least one of the characteristics as entered by the user, to the extent that the tax information is available. At step 5, the ETP is then subtracted from the IPA to provide a tax adjusted installment payment amount (tIPA). At step 6, the Pv is calculated by multiplying the tIPA by the number of payments, and then adjusting the product by an interest rate determined in accordance with the credit worthiness indicator and the type of mortgage. At step 7, the Pv is increased by a factor of 5% to obtain the uPv and decreased by a factor of 20% to obtain the lPv, thereby establishing the Pv range. The processor then identifies at step 8 those items having a price with the Pv range and which include at least one of the characteristics of the item as entered by the user. The results of the selection are then displayed to the user at step 9.

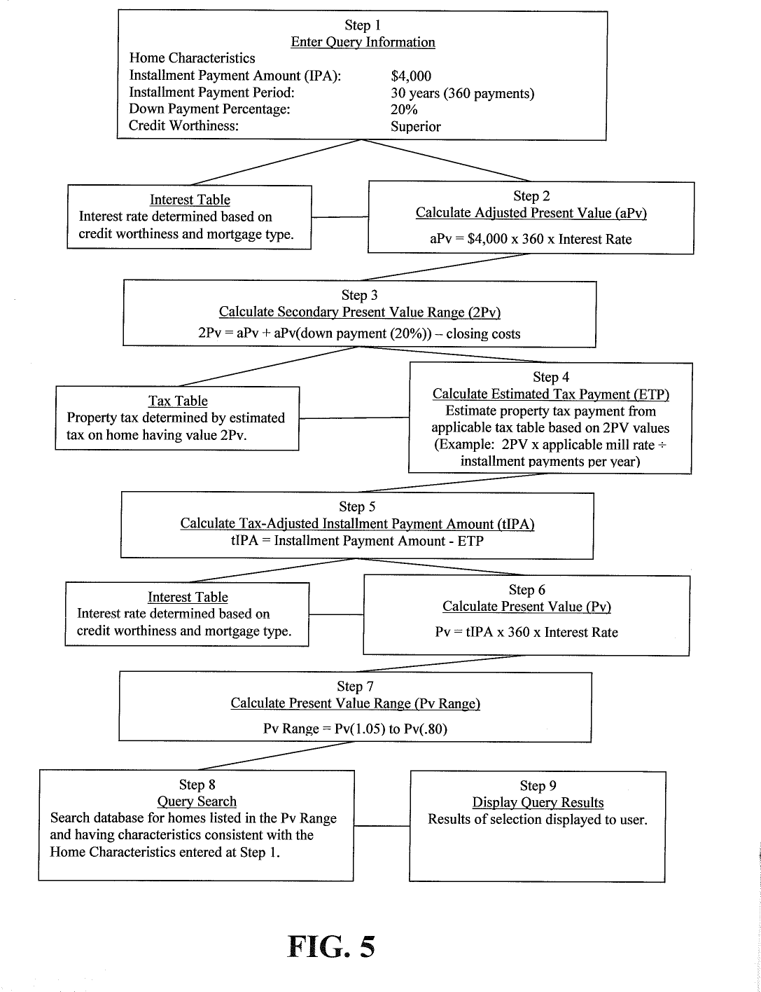

FIG. 5 illustrates yet another method for calculating the present value for the purchase of a residential house, but including a discount for annual property taxes to be paid on the home and an estimate of closing costs. The process is the same as described for FIG. 4 above, except that the 2Pv is calculated by simply adding a down payment amount to the aPv, and then adjusting the 2Pv by subtracting any estimated closing costs anticipated to be charged to the consumer. Such closing costs may include, without limitation, title insurance, agent fees, appraisal fees, bank charges and transaction costs, and costs associated with recording any property deeds.

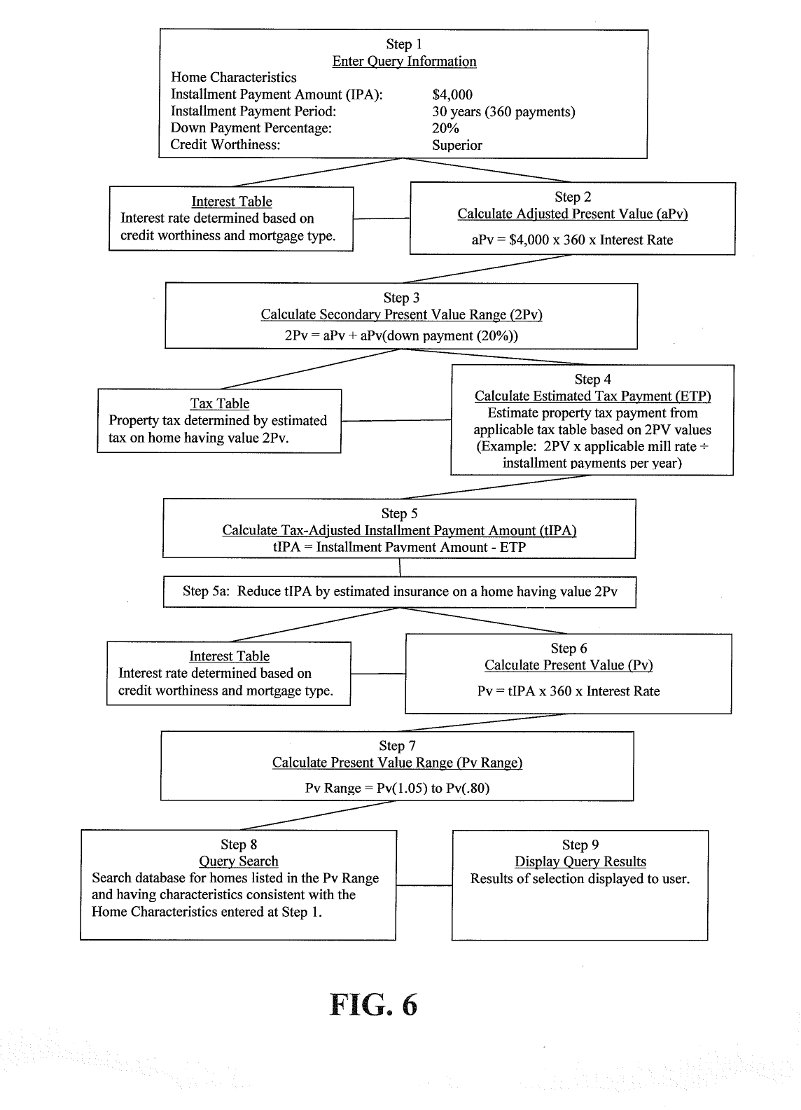

FIG. 6 illustrates yet another method for calculating the present value for the purchase of a residential house, but including a discount for annual property taxes to be paid on the home and an estimate of insurance costs. The process is the same as described for FIG. 5 above, except that the tIPA is further adjusted by subtracting an estimated insurance payment associated with the property. The insurance payment may be calculated based on the average homeowners insurance premium to be charged against a property assessed at 2Pv in the municipality selected by the user, and then divided by the number of installment payments per year selected by the user. The average homeowners insurance premium may be established by the host, a subscribing insurance provider, or from a public or private database posting average insurance premiums.

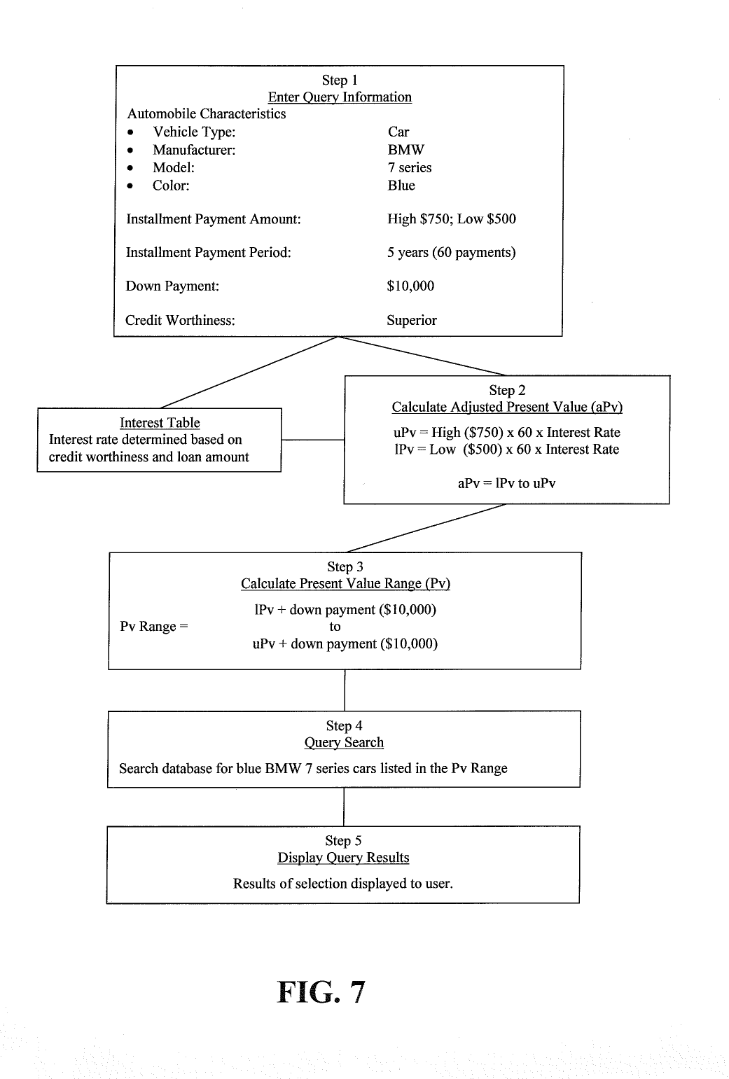

FIG. 7 illustrates a method for calculating the present value for the purchase of a car. The user has entered on the query screen in step 1 the characteristics of the desired car, the desired installment payment amount, the number of payments to be made, a down payment amount, and a credit worthiness indicator for the purchaser. The process is similar to that described above for FIG. 3, except that the characteristics are specific to automobiles.

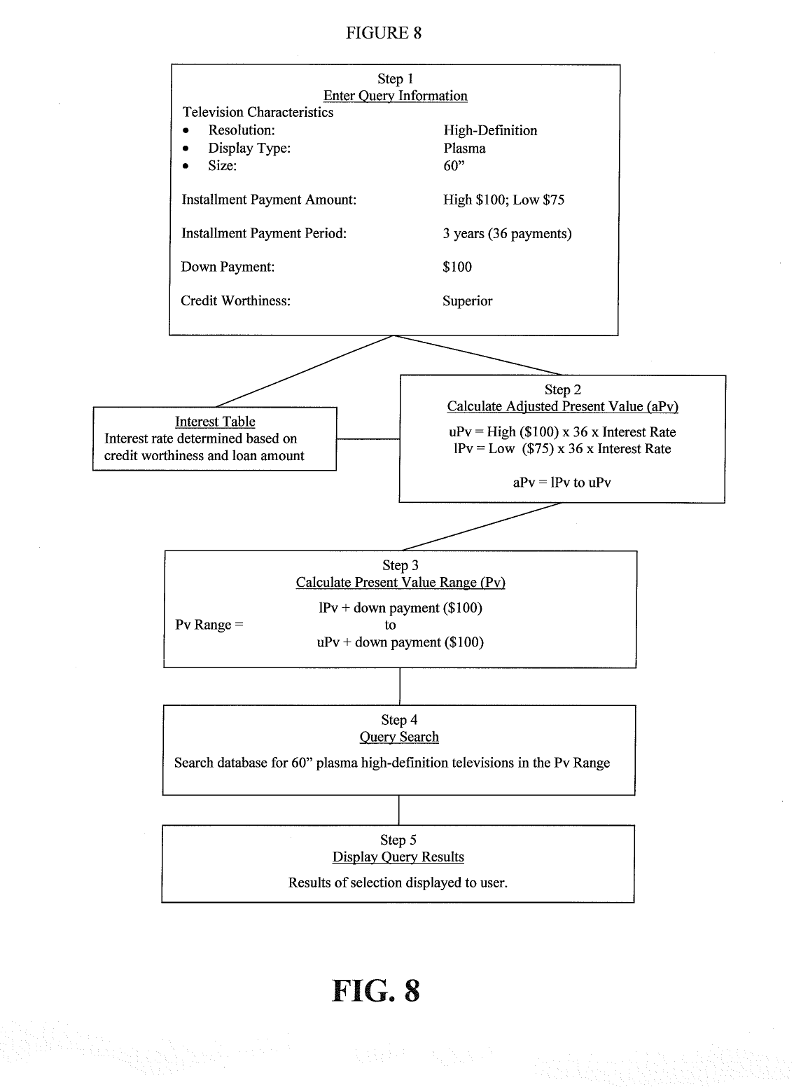

FIG. 8 illustrates a method for calculating the present value for the purchase of a television. The user has entered on the query screen in step 1 the characteristics of the desired television, the desired installment payment amount, the number of payments to be made, a down payment amount, and a credit worthiness indicator for the user. The process is similar to that described above for FIG. 3, except that the characteristics are specific to televisions.

The system is designed to accommodate a user for searching items over the internet. In one embodiment, the system includes a database for storing data records, each record containing information about a collection of items, a communications server providing communications access for users to the database, and a host processor connected between the database and the communications server through which data is exchanged between the database and the communications server. The host processor hosts the query template for requesting and transmitting to the user information from the database based on the factors inputted by the user.

The system may also be designed to allow a user to search for items over a network, such as at a store from which the items are sold, leased or rented. In this embodiment, the system may include a database for storing data records and a host processor connected to the database. The host processor hosts the query template for requesting and transmitting to the user information from the database based on the factors inputted by the user.

The method and system provides a valuable tool for searching for items of interest over the internet or directly at a location associated with the place where such items are sold. When used for searching over the internet, the system may be accessed directly at the website of the host or at a website for a subscriber utilizing the services of the host. The subscribers may include, without limitation, financial institutions interested in providing lending services, insurance providers, service providers, brokers, sales agents, legal representatives, contractors, shipping services, insurance providers and installers. If accessed through a subscriber, the display page may be constructed so that only information pertaining to the subscriber is displayed along with the search results and information regarding the selection criteria. In other embodiments, the host or subscriber may allow for the display of information regarding other persons or entities providing goods or services associated with the items, but who are not competitors of the subscriber.

If the system is accessed by a user through the website of the host, the display screen may be constructed to include information for an individual or entity (a subscriber) that has contracted with the host to have their information displayed. In one embodiment, the system may be configured to display information regarding one or more subscribers based on the item of interest, the credit worthiness indicator entered by the user, the installment payment amount, the time period for making such payments, and the characteristics of the item of interest entered by the user, including the location in which the item of interest is located. For example, when searching for real estate, the system may be configured to display, based on the location of the property, a real estate agent, moving company and painter servicing the area in which the property is located. When searching for automobiles, the system may be configured to display a dealership, service station, or car wash based on the location of the vehicle.

The system may also be configured to display information about a subscriber based on the profile of the purchaser as established form the information entered on the query screen, such as the purchaser's credit worthiness, the present value of the item being acquired, down payment amount, installment payment amount, number of installments, etc. For example, a lender, real estate agent or broker may only be interested in certain clientele or item offerings. In such event, the subscriber may wish only to have its information displayed to those individuals meeting a profile as defined by the subscriber, such as credit worthiness, total loan value, down payment, etc. The lender, real estate agent or broker may also be interested in promoting different programs to different purchasers based on various profiles established by the subscriber, such as favorable interest rates to individuals with a high credit worthiness score or providing large down payments, reduced commissions for large home acquisitions, financial incentives relevant to the geographical area, item location or type, or other special programs then be offered for like purchasers and items of interest.

In addition to the above, the various processing approaches described herein can be implemented using a variety of devices and methods including general purpose processors implementing specialized software, digital signal processors, programmable logic arrays, discrete logic components and fully-programmable and semi-programmable circuits. For example, the disclosed algorithms may be executed on a microcomputer (a.k.a. microprocessor) in connection with certain embodiments, and may be implemented as part of one or more of the devices shown in the figures.

While the present invention has been described above and in the claims that follow, those skilled in the art will recognize that many changes may be made thereto without departing from the spirit and scope of the present invention. The described embodiments and examples are to be considered in all respects only as illustrative and not restrictive.

What is claimed is:

1. For implementation by a computer arrangement, a method for facilitating access and processing of a plurality of item-related data sets stored in a database, each item-related data set corresponding to a respective item and including a respective lump sum payment value, the computer arrangement implementing the method by performing the following steps:
receiving an access request that indicates an amount to be paid periodically;
algorithmically computing, as a function of the amount to be paid periodically, a lump sum parameter indicative of a lump sum payment amount; and
transmitting search criteria including the generated lump sum parameter to identify items in the database at least by the associated lump sum payment value.

2. A system for facilitating access and processing item-related data sets stored in a database, each item-related data set corresponding to a respective item and including a respective lump sum payment value, the system comprising a computer arrangement for
receiving an access request that indicates an amount to be paid periodically;
algorithmically computing, as a function of the amount to be paid periodically, a lump sum parameter indicative of a lump sum payment amount; and
transmitting search criteria including the generated lump sum parameter to identify items in the database by the associated lump sum payment value.

3. A computer readable medium comprising computer executable instructions adapted to perform, or comprising data arranged for use with, a computer-implemented method for facilitating access and processing item-related data sets stored in a database, each item-related data set corresponding to a respective item and including a respective lump sum payment value, the method including the following steps:
receiving an access request that indicates an amount to be paid periodically;
algorithmically computing, as a function of the amount to be paid periodically, a lump sum parameter indicative of a lump sum payment amount; and
transmitting search criteria including the generated lump sum parameter to identify items in the database at least by the associated lump sum payment value.

4. The method of claim 1, wherein the items include real estate, vehicles, electronic devices, home appliances, furniture, or services that include at least one of remodeling, dental, medical, insurance, investment, or travel.

5. The method of claim 1, wherein the search criteria include one or more additional parameters used to identify items in the database.

6. The method of claim 5, further comprising receiving user profile data associated with the access request, the one or more additional parameters generated from the user profile data.

7. The method of claim 5, wherein the one or more additional parameters are selectable from a set of characteristics included in the item-related data sets.

8. The method of claim 7, wherein for item-related data sets relating to real estate, the set of characteristics includes one or more of location, number of bedrooms, number of bathrooms, living area, property size, age, school district, garage size, garage type, room dimensions, or property taxes.

9. The method of claim 7, wherein for item-related data sets relating to vehicles, the set of characteristics includes one or more of location, vehicle make, vehicle model, vehicle year, vehicle equipment, fuel efficiency, vehicle color, or transportation costs.

10. The method of claim 1, wherein the access request further indicates a time period for the amount to be paid periodically.

11. The method of claim 1, wherein the amount to be paid periodically is provided by a user.

12. The method of claim 1, wherein the amount to be paid periodically is calculated from one or more of income, current payment obligations, and spending reports.

13. The method of claim 1, wherein the amount to be paid periodically is expressed as a range, a fixed amount, or an amount that varies over time.

14. The method of claim 1, wherein the lump sum parameter takes into account a non-recurring expense.

15. The method of claim 14, wherein the non-recurring expenses includes one or more of a down payment, interest rate points, a service fee, closing costs, a processing fee, sales taxes, or a service plan fee.

16. The method of claim 1, wherein the lump sum parameter takes into account recurring expenses.

17. The method of claim 16, wherein the recurring expenses includes one or more of taxes, insurance, or maintenance costs.

18. The method of claim 1, wherein algorithmically computing the lump sum parameter includes estimating one or more of a financing rate, a financing term, taxes, insurance, or maintenance costs.

19. The method of claim 18, wherein the step of estimating is based upon a preliminary identification of items in the database from search criteria other than the lump sum parameter.

20. The method of claim 1, wherein algorithmically computing the lump sum parameter includes determining a financing rate.

21. The method of claim 20, wherein determining the financing rate is based upon a credit worthiness indicator.

22. The method of claim i, wherein algorithmically computing the lump sum parameter includes selecting from a set of different payment algorithms based on one or more of fixed or variable financing rate, term of financing, type of financing provider, term of ownership, or purpose of purchase.

23. The method of claim 1, further comprising generating and storing a user-associated payment profile for use in the step of algorithmically computing the lump sum parameter.

24. The method of claim 23, wherein the user-associated payment profile includes the amount to be paid periodically along with one or more of a credit worthiness indicator, financial obligation data, or financing preferences.

25. The method of claim 1, further comprising storing the identified items.

26. The method of claim 1, further comprising displaying the identified items.

27. The method of claim 26, wherein displaying the identified items includes displaying one or more advertisements along with the identified items.

28. The method of claim 27, wherein the one or more advertisements are selected for display based on the identified items.

29. The method of claim 27, wherein the one or more advertisements are selected for display based on one or more parameters used to identify the identified items.

30. The method of claim 26, wherein displaying the identified items includes displaying an expected periodic payment amount associated with each identified item, each expected periodic payment amount determined based upon the computing of the lump sum parameter and the lump sum payment value for the associated item.

31. The method of claim 26, wherein displaying the identified items includes displaying for each identified item one or more of taxes, periodic payment, payment term, expected insurance costs, expected maintenance costs, or expected utilities costs.

32. The method of claim 1, wherein the database includes one or more internet-accessible databases.

33. The method of claim 32, wherein the one or more internet-accessible databases includes multiple listing service databases for real estate in one or more states.

34. The method of claim 32, wherein the one or more internet-accessible databases includes one or more online sales sites.

35. The method of claim 1, wherein the database includes one or more privately-accessible databases.
